(19) United States
(12) Patent Application Publication
(10) Pub. No.: US 2008/0220405 A1
(43) Pub. Date: Sep. 11, 2008

(54) MAGNETIC DISPLAY FOR USE BY COACHES AND TRAINERS OF VARIOUS SPORTS

(76) Inventor: Martin Lynch, Oak Brook, IL (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 12/122,922

(22) Filed: May 19, 2008

Related U.S. Application Data
(63) Continuation-in-part of application No. 11/697,109, filed on Apr. 5, 2007.
(60) Provisional application No. 60/789,416, filed on Apr. 5, 2006.

(51) Int. Cl. B43L 1/00

(52) U.S. Cl. 434/409

(57) ABSTRACT

A display device or diagramming a play includes a housing. A recess of the housing receives a display panel filled with a layer of magnetic particles and on which an outline of a field of play, or a portion thereof, is drawn. A stylus has a tip end which, when brought into contact with, or in close proximity to, an outer surface of the panel attracts the magnetic particles to the underside to form an image visible to anyone looking at the panel. The user can create as many images as he needs to diagram a play for his team. When done, the user moves a magnetic band underneath the length of the panel to erase the display.

### CROSS-REFERENCE TO RELATED APPLICATIONS

This application is a continuation-in-part of U.S. patent application Ser. No. 11/697,109, filed Apr. 5, 2007, which is related to U.S. Provisional Patent Application No. 60/789,416 filed Apr. 5, 2006 from which priority is claimed, and is hereby incorporated by reference.

### STATEMENT REGARDING FEDERALLY SPONSORED RESEARCH

Not Applicable.

### BACKGROUND OF THE INVENTION

This invention relates to the diagramming of plays for a team by a coach or trainer; and, more particularly, to a magnetic display for quickly and easily communicating a play to team members without the use of paper, pen, pencils, or markers.

Everyone who watches sports on television has seen it. At a crucial point in a basketball game, a football game, or other sporting event, the coach calls a “time out” and assembles the team about him on the sideline of the court or field. With the team gathered around, the coach or one of his assistants takes out a display board, such as clipboard or a dry-erase board, along with an appropriate writing instrument, such as a pen, pencil, or marker, and diagrams an offensive play for the team to run, or a defensive set in anticipation of the opposing team's play.

Typically, the display board includes a layout of at least a portion of the field of play (e.g. a basketball court, or one end of a football or soccer field, etc.), and the coach marks the players' starting positions on the display board. Then, the coach diagrams instructions on the display board for each player with the writing instrument by drawing lines that represent a players movement from a starting position to a desired ending position. Usually, the resulting display board exhibits a myriad of straight and/or curved lines with many of the lines intersecting one another. If the coach makes a mistake or decides to diagram an alternate play, he must first erase the existing lines drawn on the display board by rubbing with an eraser or other cloth, or tearing off a used sheet of paper so there is a clean display board for drawing. This process uses up valuable coaching time during “time-outs”, which are of relatively short duration. In addition, if the display is not cleanly erased, any remaining lines denoting the previously delineated play can confuse the players and result in the improper execution of the newly diagrammed play or defense.

### SUMMARY OF THE INVENTION

Briefly stated, the invention is a display device for use by coaches and others to quickly and easily diagram plays for their team, and to quickly “erase” the diagrammed play so another play can be diagrammed. The device is self-contained and does not require paper, pencils, pens, or magic markers or the like for diagramming the plays.

The display comprises a lightweight, hand-held portable unit including a display panel or template on which is outlined the field of play, or a portion thereof, for a particular sport. Various fields of play, or portions of them, are outlined on the display panels of different devices so coaches for the respective sports will have a device readily available to them for diagramming plays for their sport. The drawing surface employs one of a plurality of magnetophoretic or magnetic display screens by which the user uses a stylus or the like to attract magnetic particles to the underside of the display screen. This allows illustration of player movement from an initial position through a sequence of moves to execute a desired play. When diagramming is complete, the user moves a slide or other device underneath the panel to de-magnetize the particles and erase the display.

The foregoing and other features, and advantages of the invention as well as embodiments thereof will become more apparent from the reading of the following description in connection with the accompanying drawings.

### DESCRIPTION OF THE DRAWINGS

In the accompanying drawings which form part of the specification:

FIG. 1 is a perspective view of the display device of the present invention for diagramming plays, a portion of the device being shown in section, and including a stylus for writing on the surface of the display; and

FIG. 2 is a perspective view of the display device displaying one-half of a basketball court;

FIG. 3 is a perspective view of the display device displaying a portion of a football field;

FIG. 4 is a perspective view of the display device displaying a portion of a soccer field;

FIG. 5 is a perspective view of an alternate embodiment of a display device;

FIG. 6 is a perspective view of a bottom of the display device;

FIG. 7 is a enlarged perspective view of a clip of the display device;

FIG. 8 is a top view of a second alternate embodiment of a display device;

FIG. 9 is a sectional view along A-A of FIG. 8 of the second alternate embodiment of the display device;

FIG. 10 is perspective view of a stylus of the second alternate embodiment of the display device; and

FIG. 11 is bottom view of the second alternate embodiment of the display device with the stylus engaging a lower surface of the display device.

Corresponding reference numerals indicate corresponding parts throughout the several figures of the drawings.

### DETAILED DESCRIPTION

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

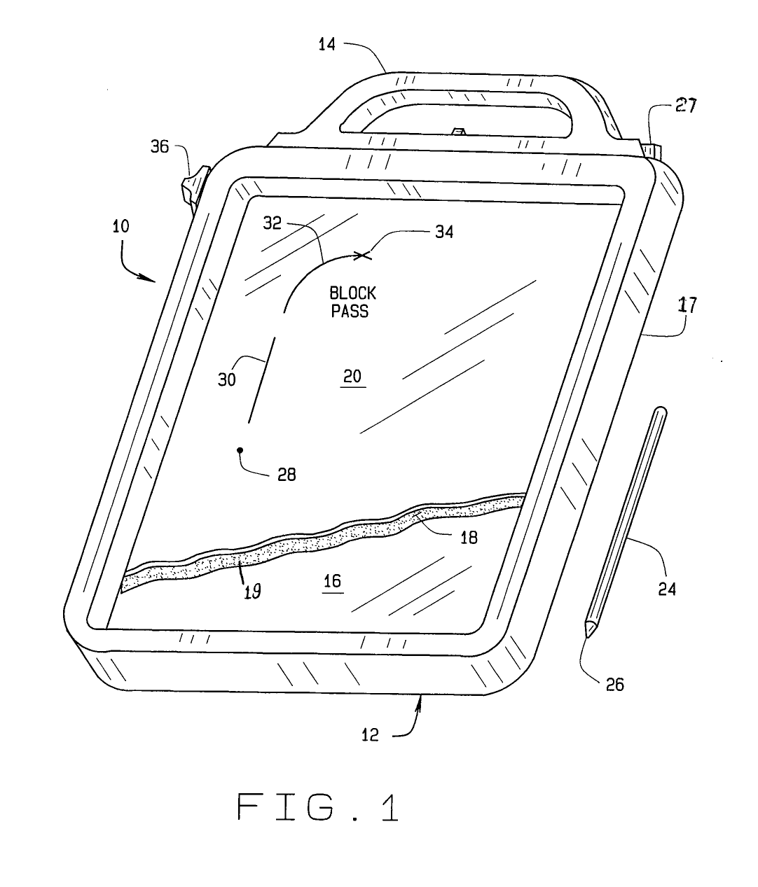

As shown in FIGS. 1-4, an embodiment of the present invention, generally referred to as a display device 10, includes a generally rectangular case or housing 12 preferably made of a molded, lightweight, high-impact plastic material, and non-magnetic material. A molded handle 14 extends from one end of housing 12 for convenient lifting, holding and carrying of the display device 10. The housing 12 includes a generally flat lower member 16 with side members 17 extending upwardly from the edges of the lower member 16. A display panel 20 extends between the side members 17 to define a compartment within the housing 12. A layer of magnetic particles 18 reside within in the compartment 19 (FIG. 1).

The display panel 20 and magnetic particles 18 interact to form images on the display panel 20, preferably using a type of magnetophoretic phenomena. For example, the magnetic particles 18 can comprise either microcapsules of a magnetic material or a beehive cone of particles. A display device 10 using such magnetophoric phenomena allows a user to repeatedly form images on the display panel 20, that can be readily erased without leaving a residual image.

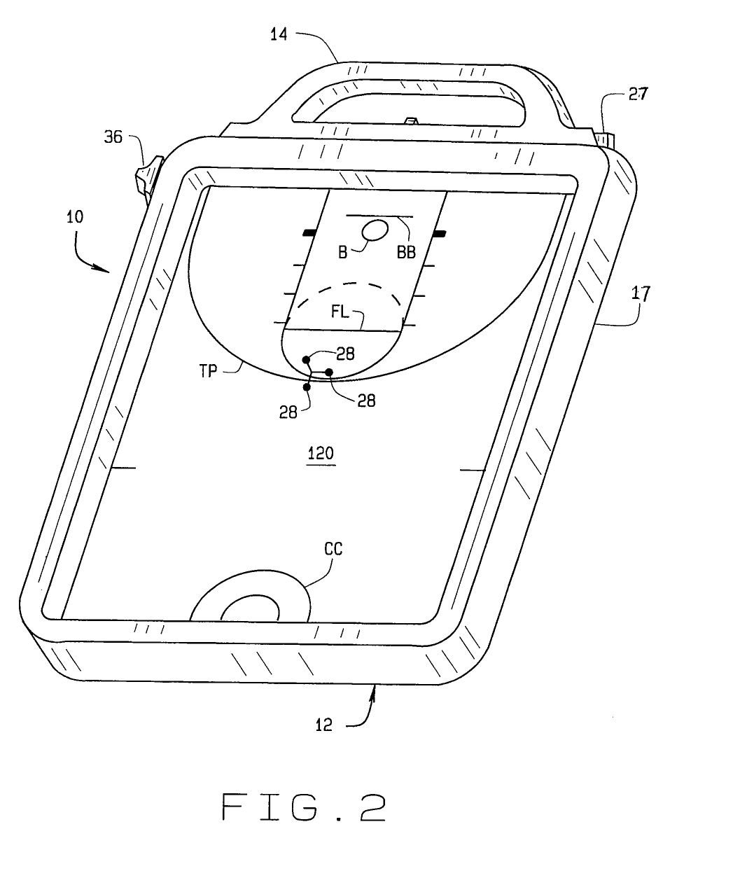

A template 21 on the display panel 20 represents a playing surface of a sport or athletic activity. The template 21 can be applied to the display panel 20 using any appropriate method, such as silk-screening, engraving, etching, printing, an adhesive label, or other suitable method. The template 20 can represent the playing surface of any sport or athletic activity, such as, baseball, soccer, basketball, football, tennis, volleyball, hockey, rugby, field hockey, lacrosse, cricket, dodgeball, or other sports. For example, the template 120 illustrated in FIG. 2 represents half of a basketball court having a basket B, backboard BB, free throw line FL, three-point arc TP, and a portion of the center circle CC at the half-court of the basketball court. Three dots 28 representing different players are shown on the display.

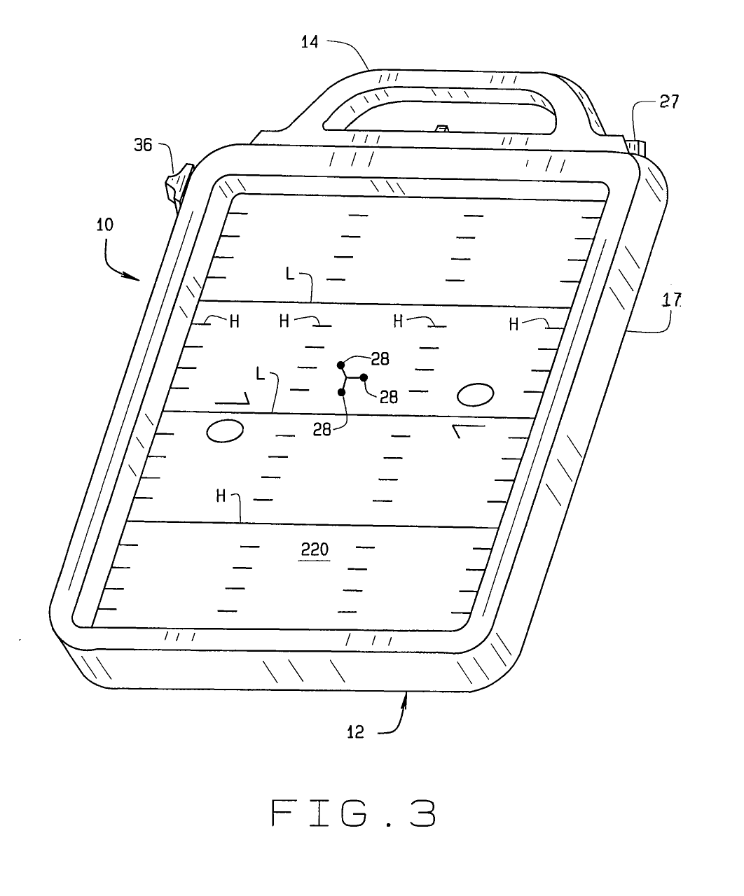

In FIG. 3, the template 220 represents a portion of a football field with lines L extending completely across the field at five-yard intervals, together with hash marks H on either side of the field, and along the side of the field (four marks in all) denoting each yard of play. Again, three dots 28 representing different players are shown on the display.

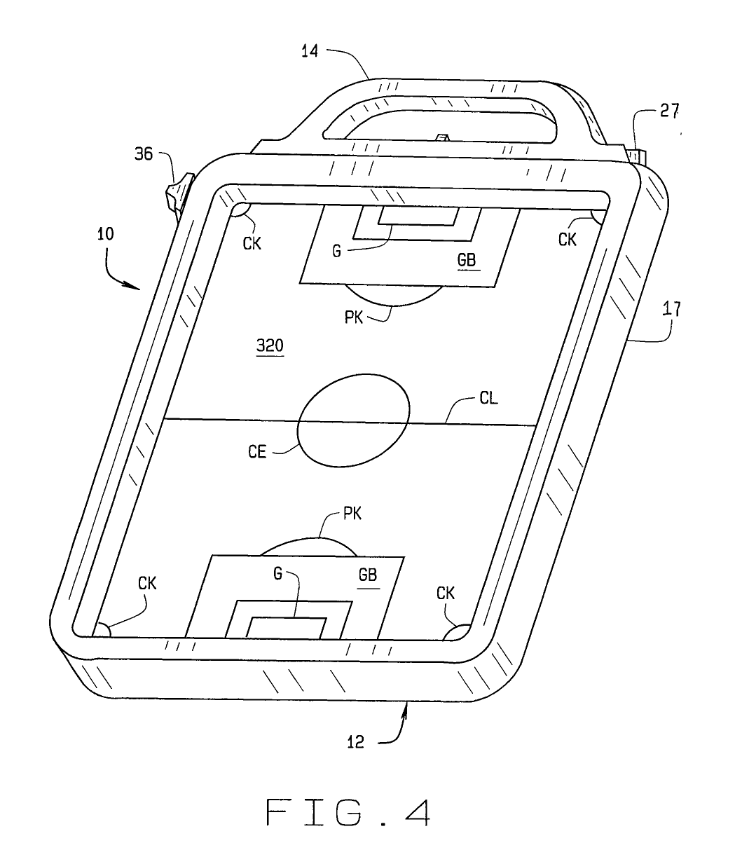

In FIG. 4, the template 320 represents a soccer field with goals G at each end of the field, corner kick areas CK at each corner of the field, a goalie box GB, a penalty kick area PK, a center line CL, and a center circle CE.

A writing instrument, preferably a stylus 24, includes a magnetic tip 26 for writing on the display panel 20. When not in use, the stylus 24 can be stored within a cavity 27 of the housing 12. As a user brings the tip 26 into contact with or in close proximity to the outer surface of the display panel 20, the tip 26 attracts the magnetic particles 18 to the inner surface of the display panel 20 with a magnetic field so that the particles 18 form an image (e.g., a dot 28) which is visible on the outer surface of the display panel 20. In this way, the user can move the tip 26 of the stylus 24 about the display panel 20 to form a desired image. The user lifts the tip 26 from the display panel 20 to stop formation of the image. If the user then places the stylus against or adjacent another location on the display, he will create another dot, and can begin another image. For example, a desired image can include a straight line 30, curved line 32, dot 28, an arrow 34 to indicate a direction of movement, words, such as, “block” or “pass” to indicate a particular activity, or any combination thereof.

The image on the display panel 20 can be erased with a slide member 36 moveably mounted with a slot 37 of the housing 12 and positioned below the inner surface of the display panel 20. The slide member 36 produces a magnetic field opposite to that created by the tip 26 of stylus 24 and repels the magnetic particles away from the inner surface of the display panel 20, thereby erasing the display panel 20. The display panel 20 is now “clean” and the user can use the stylus 24 to create a new image. The slide member 36 erases the display without the need for any other cleaning materials, such as an eraser, or a spray bottle and rag.

The display device 10 is preferably made of plastic materials that provide both durability and can withstand exposure to elements that are present during both indoor and outdoor athletic activities.

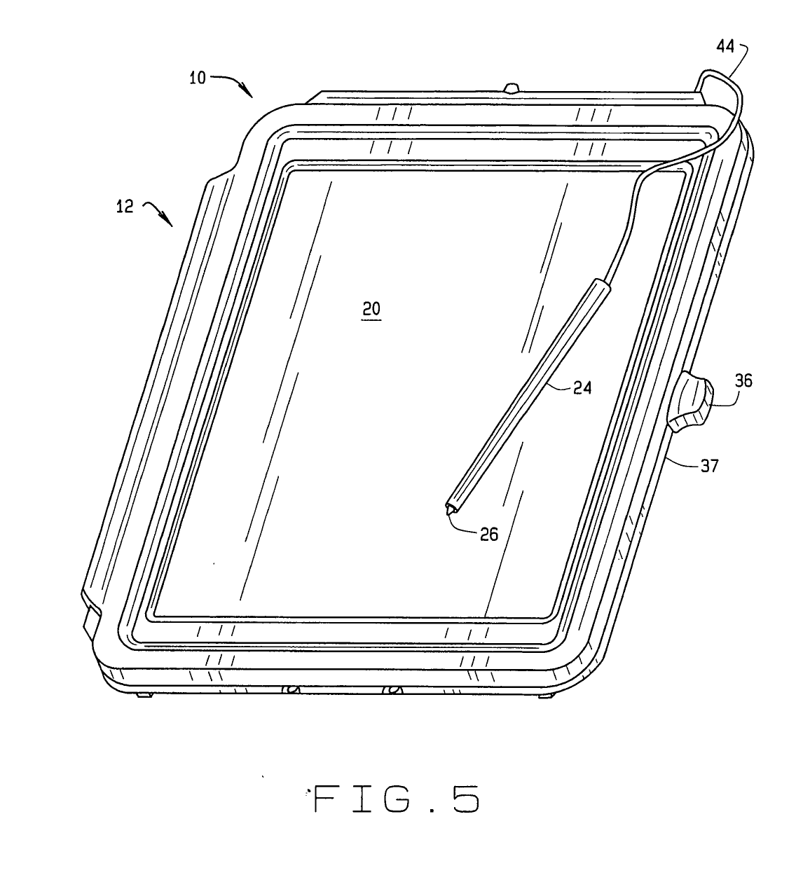

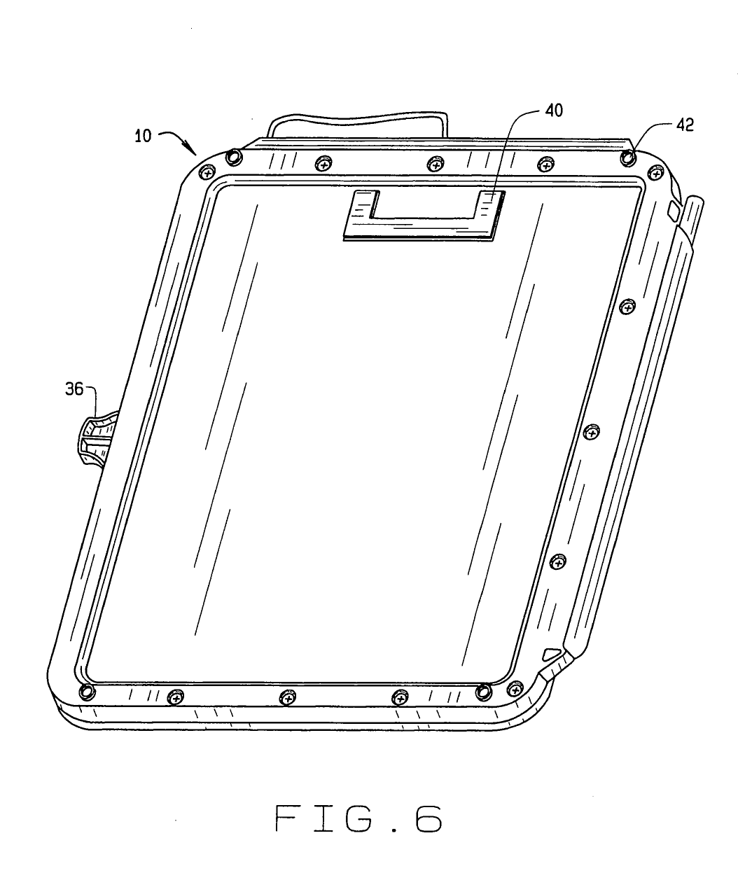

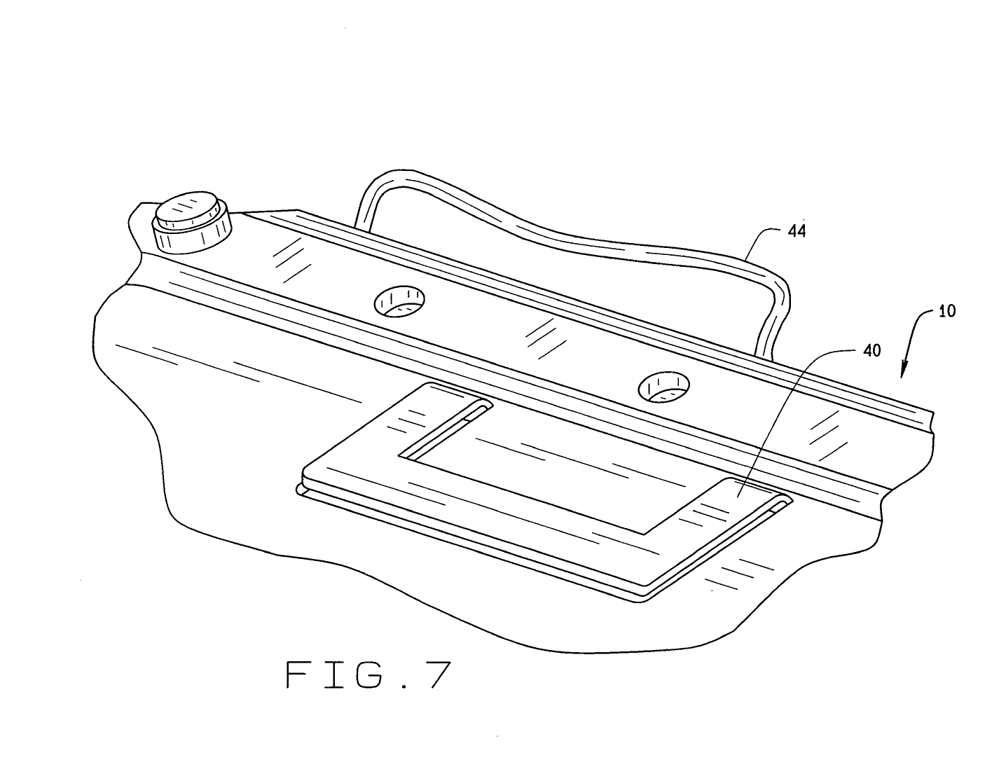

In an alternate embodiment (FIGS. 5-7), the display device 10 does not include a handle 14, but rather includes a clip 40 protruding from the lower surface of the display device 10. The alternate embodiment also includes feet 42, such as rubber or felt, that support the display device 10 when placed on a supporting surface. The feet 42 reduce slipping of the device on the supporting surface. In addition, the stylus 24 is attached to the display device 10 with a tether 44, such as a cord, string, and the like.

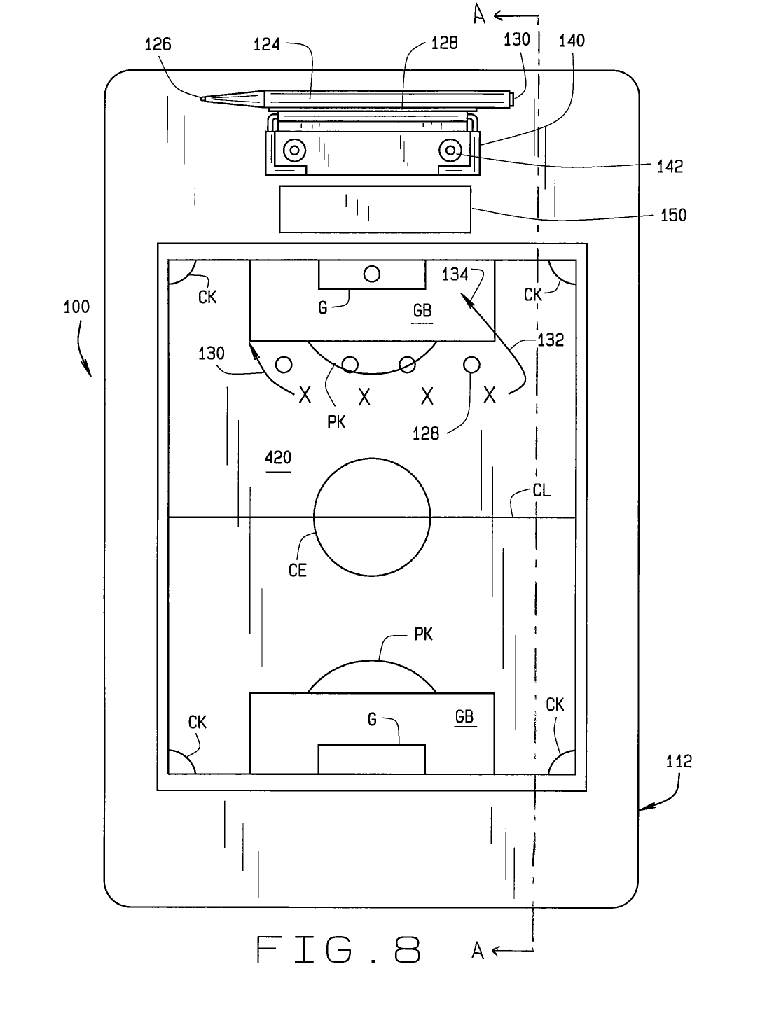

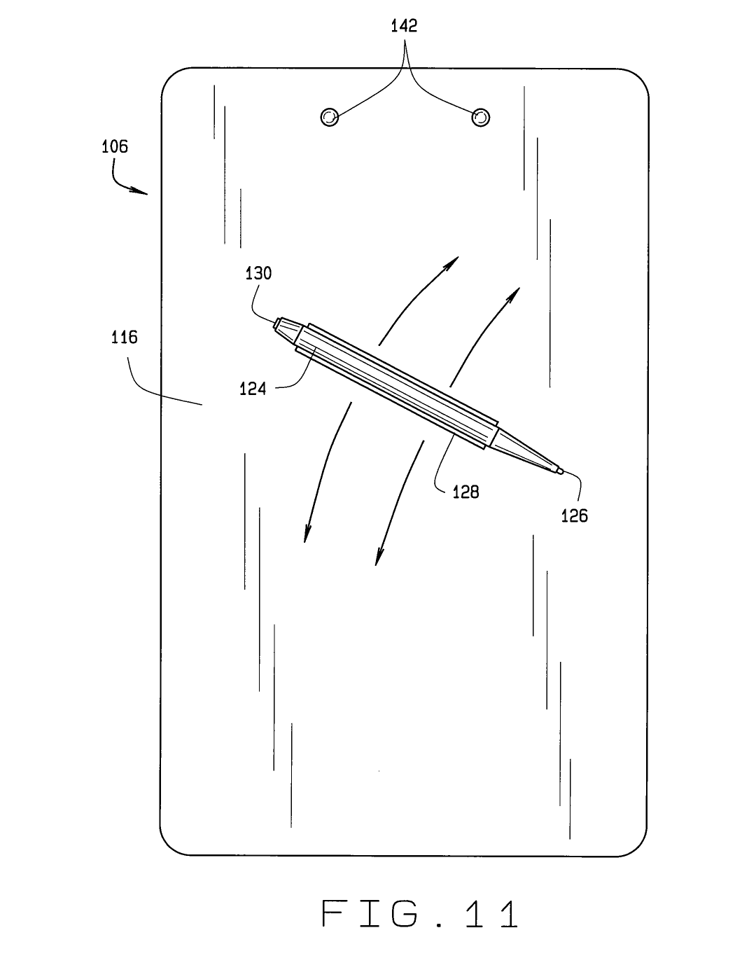

As shown in FIGS. 8-11, a second alternate embodiment of the present invention, generally referred to as a display device 110, includes a generally rectangular housing 112 preferably made of a molded, lightweight, high-impact plastic material, and non-magnetic material. The housing 112 is a generally flat panel defining a generally rectangular recess 114 within an upper surface 116 for receiving a display panel 420. A clip 140 is attached to the housing 112 using appropriate fasteners 142. The clip 140 can be used for securing various items to the housing 112, such as papers.

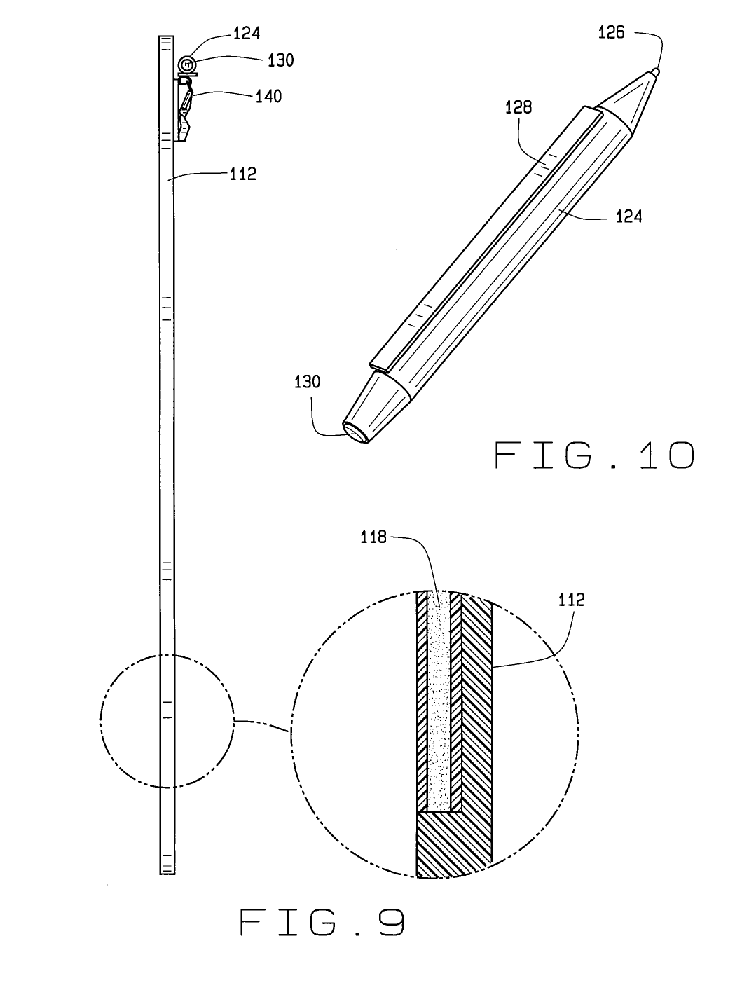

A layer of magnetic particles 118 resides within the display panel 420 that interacts with the display panel 420 to form images, preferably using a type of magnetophoretic phenomena. For example, the magnetic particles 118 can comprise either microcapsules of a magnetic material or a beehive cone of particles (FIG. 9). In the embodiment of FIGS. 8-11, the display panel 420 is preferably a magnetophoretic film, such as the microcapsule film. The magnetophoretic film is preferably secured within the recess 114 with an adhesive, but any appropriate method can be used. A display device 110 using such magnetophoric phenomena allows a user to repeatedly form images on the display panel 420, that can be readily erased without leaving a residual image.

A template 421 on the display panel 420 represents a playing surface of a sport or athletic activity. The template 421 can be applied to the display panel 420 using any appropriate method, such as silk-screening, engraving, etching, printing, an adhesive label, or other suitable method. The template 421 can represent the playing surface of any sport or athletic activity, such as, baseball, soccer, basketball, football, tennis, volleyball, hockey, rugby, field hockey, lacrosse, cricket, dodgeball, or other sports. For example, the template 421 illustrated in FIG. 8 represents a soccer field with goals G at each end of the field, corner kick areas CK at each corner of the field, a goalie box GB, a penalty kick area PK, a center line CL, and a center circle CE.

A writing instrument, preferably a stylus 124, includes a magnetic tip 126 for writing on the display panel 420. A larger magnetic tip 127 positioned on the opposite end of the stylus 124 from the magnetic tip 126, can be used to form larger images. A generally rectangular magnetic band 129 extends longitudinally along an outer portion of the stylus 124. When not in use, the stylus 124 can be stored by removeably attaching the magnetic band 129 to the clip 140.

As a user brings the tip 126 into contact with or in close proximity to the outer surface of the display panel 420, the tip 126 attracts the magnetic particles 118 to the inner surface of the display panel 420 with a magnetic field so that the particles 118 form an image (e.g., a dot 128) which is visible on the outer surface of the display panel 420. In this way, the user can move the tip 126 of the stylus 124 about the display panel 420 to form a desired image. The user lifts the tip 126 from the display panel 420 to stop formation of the image. If the user then places the stylus 124 against or adjacent another location on the display, he will create another dot, and can begin another image. For example, a desired image can include a straight line 130, curved line 132, dot 128, an arrow 134 to indicate a direction of movement, words, such as, “block” or “pass” to indicate a particular activity, or any combination thereof.

The image on the display panel 420 can be erased with the magnetic band 129 of the stylus 124 by moving the magnetic band 129 along the lower surface of the housing 112. The magnetic band 129 produces a magnetic field opposite to that created by the tip 126 of stylus 124 and repels the magnetic particles away from the inner surface of the display panel 420, thereby erasing the display panel 420. The display panel 420 is now “clean” and the user can use the stylus 124 to create a new image. The magnetic bar 129 erases the display panel 420 without the need for any other cleaning materials, such as an eraser, or a spray bottle and rag.

The display device 110 is preferably made of plastic materials that provide both durability and can withstand exposure to elements that are present during both indoor and outdoor athletic activities.

Changes can be made in the above constructions without departing from the scope of the invention, it is intended that all matter contained in the above description or shown in the accompanying drawings shall be interpreted as illustrative and not in a limiting sense. For example, the template can be removeable and replaceable, such as an overlay.

What is claimed is:

1. A display device for diagramming a play for a player or team, comprising:
a housing;
a display panel supported on the housing, the display panel having a template representing a playing surface for an athletic activity;
a plurality of magnetic particles within the display panel; and
a writing instrument moveable over the display panel to create an image representing a players position and movement during a play, the writing instrument creating a magnetic field drawing the magnetic particles to an inner surface of the display panel where they are visible by a viewer;
a magnetic band along a portion of the writing instrument which, when brought into contact with, or in close proximity to, a lower surface of the housing attracts the magnetic particles away from the inner surface of the display panel to erase an image visible to the viewer looking at the display panel.

2. The display device of claim 1, the writing instrument comprising a stylus having a magnetic tip which, when brought into contact with, or in close proximity to, an outer surface of the display panel attracts the magnetic particles to the inner surface of the display panel to form an image visible to the viewer looking at the panel.

3. The display device of claim 1, in which a drawing surface provided by the display panel employs magnetophoretic phenomena to produce the display.

4. The display device of claim 1, wherein the template is a playing surface selected from the group consisting of baseball diamond, soccer field, basketball court, football field, tennis count, volleyball court, hockey rink, rugby field, field hockey field, lacrosse field, cricket field, or dodgeball court.

5. A display device for diagramming a play for a player or team, comprising:
a housing;
a display panel attached to the housing, the display panel having an image of at least a portion of a field of play; and,
a plurality of magnetic particles within the display panel;
a diagramming means by which a user diagrams a play to be performed on the field of play including indicating the starting position of at least one player on the field of play and his movements subsequent to the start of play on the field of play, the diagramming means creating a magnetic field drawing the magnetic particles to a surface of the display panel where they are visible by a viewer, with the particles depicting the player and his movements;
an erasing means including a magnetic band movable over the lower surface of the housing to remove the magnetic particles from the surface of the display panel.

6. The display device of claim 5, the diagramming means comprising a stylus having a tip which, when brought into contact with, or in close proximity to, an outer surface of the display panel attracts the magnetic particles to the inner surface of the display panel to form an image visible to the viewer looking at the panel.

7. The display device of claim 5 in which a drawing surface provided by the panel employs magnetophoretic phenomena to produce the display.

8. The display device of claim 5 wherein the image is a field of play selected from the group consisting of baseball diamond, soccer field, basketball court, football field, tennis count, volleyball court, hockey rink, rugby field, field hockey field, lacrosse field, cricket field, or dodgeball court.

9. A method of diagramming a play for a player or team on a display device, comprising:
providing a housing;
providing a display panel supported by the housing, the display panel having a template representing a playing surface for an athletic activity;
providing a plurality of magnetic particles within the display panel; and
providing a writing instrument;
moving the tip of the writing instrument over the display panel to create an image by drawing the magnetic particles to an inner surface of the display panel where they are visible by the player or team;
creating an image on the display panel with the writing instrument that represents a player or a teams movement about the playing surface during a play;
providing a magnetic band on the writing instrument; and
moving the band along the lower surface of the housing to remove the magnetic particles from the display panel.

10. The method of diagramming a play for a player or team on a display device of claim 9, wherein the template is a playing surface selected from the group consisting of baseball diamond, soccer field, basketball court, football field, tennis count, volleyball court, hockey rink, rugby field, field hockey field, lacrosse field, cricket field, or dodgeball court.

11. The method of diagramming a play for a player or team on a display device of claim 9, in which a drawing surface provided by the display panel employs magnetophoretic phenomena to produce the display.
